(19) United States
(12) Patent Application Publication
(10) Pub. No.: US 2009/0254881 A1
(43) Pub. Date: Oct. 8, 2009

(54) CODE GENERATION TECHNIQUES FOR ADMINISTRATIVE TASKS

(75) Inventors: Kevin Michael Johnson, Huntington, NY (US); Robert David Posner, Huntington Station, NY (US); Yang Liu, Hebron, CT (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/062,826

(22) Filed: Apr. 4, 2008

(51) Int. Cl. G06F 9/44

(52) U.S. Cl. 717/117

(57) ABSTRACT

Techniques for using a declarative programming language to automatically generate imperative language computer programs (such as the get, set, enable, and disable commands of the Windows® PowerShell scripting language) that perform administrative tasks of computing environments. A code generator 150 is operative to process a declarative language document, which includes at least three hierarchically-related data structures. The first data structure references certain administrative commands; the second data structure references parameters accepted by the commands; and the third data structure provides pointers to configuration data associated with the parameters. The document is processed in accordance with a set of rules to produce imperative-language execution routines that call sub-routines and pass variables thereto, which enables differences between parameters and configuration data to be mitigated through mapping. At runtime, the sub-routine utilizes a configuration service to retrieve a map of current configuration data from memory, based on values of the variable.

### BACKGROUND

Various tools and programming languages are available to automate a range of administrative tasks of stand-alone and networked, client- and server-based computing environments. Examples of common administrative tasks include: changing directories; copying, re-naming, deleting, or retrieving the contents of files or directories; installing new computer programs; scanning for security threats; and listing, starting, or stopping various processes.

Many computing environments support command line interfaces, graphical user interfaces (“GUIs”), and/or specialized programming languages that facilitate creation and execution of computer programs that perform administrative tasks. One exemplary command line interface and scripting language, which was developed for use with certain versions of the Microsoft® Windows® operating system, is the Windows® PowerShell command line interface (“CLI”) and scripting language. The Windows® PowerShell command line interface and scripting language enables developers to use and create special computer programs, which are colloquially referred to as “cmdlets” (pronounced com-and-lets), to perform a range of administrative tasks.

Often, creating computer programs that conform to syntax rules defined for particular CLIs, GUIs, or programming languages involves custom coding numerous sets of computer-executable instructions. Although certain instructions in each set may perform fundamentally the same operation(s)—for example, accessing and processing particular resources of the computing environment such as files, directories, programs, or devices—slightly different code may be generated for accessing and/or processing different resources. In the case of cmdlets, for example, custom coding often involves repetitious coding of commands conforming to syntax rules defined for the Windows® PowerShell CLI and scripting language (common examples include the “get”, “set,” “enable,” and “disable” commands), which commands accept various parameters corresponding to different resources of the computing environment that are accessible via a paticular Windows® operating system.

When custom code is created for different combinations of administrative tasks and affected resources/configurations, the coding process can be inefficient and the resulting code inconsistent, inflexible to change, and error-prone.

### SUMMARY

Techniques for using a declarative programming language to automatically generate imperative language computer-executable instructions associated with computer programs that perform administrative tasks of computing environments are discussed herein. For purposes of example, instance, or illustration—and not limitation—the use of extensible markup language (“XML”), which is a declarative programming language, to produce computer programs referred to as cmdlets, which conform to syntax defined by the Windows® PowerShell imperative programming (scripting) language, is discussed herein. It will be understood, however, that other declarative and imperative programming languages, other administrative tool environments, and combinations thereof may be substituted without departing from the spirit or scope of the appended claims.

Initially, one or more declarative language documents that define at least three hierarchically related data structures are identified. In an exemplary scenario, one or more XML documents are identified, which include data structures in the form of markup elements or attributes thereof that are defined by nested tags.

A first data structure is populated with items of first data representing one or more commands of an imperative programming language, which correspond to actions within a particular computing environment. A second data structure is populated with items of second data representing one or more parameters accepted by one or more of the commands. A third data structure is populated with items of third data representing references to (for example, information about one or more locations of) configuration data associated with the one or more parameters (for example, pointers to temporary or persistent memory locations). Additional data structures are also possible, including but not limited to one or more data structures for storing enumerations.

Next, a set of rules for processing the document is identified. One step associated with identifying the set of rules for processing may be to create a structured representation of the document. For example, the document may be parsed into a tree structure such as a document object model (“DOM”). When a structured representation of the document is created, certain nodes correspond to unique permutations of commands and parameters populating the first and second data structures of the document, respectively.

The document is processed based on the identified set of rules, to automatically generate a number of execution routines. A particular execution routine is a set of computer-executable instructions conforming to syntax rules of a particular imperative programming language. In the case where a structured representation of the document is created, processing the structured representation causes an execution routine to be generated for each of the particular nodes corresponding to a unique permutation of a particular command represented by a particular item of first data and a particular parameter represented by a particular item of second data. In one exemplary implementation, for a particular parameter represented by a particular item of second data, an XML attribute, which holds an XPATH mapping, may be applied to the particular item of second data. Each execution routine includes an automatically generated call to a sub-routine, to which is passed a variable (which may be based on the XML attribute.) The variable is a particular item of third data associated with the particular parameter (for example, a reference serving as a pointer to a location in a computer-readable memory where configuration data associated with the parameter is stored).

When a particular execution routine is selected by a user (for example, entered into a command line interface (“CLI”) or a graphical user interface (“GUI”)) and executed, the action represented by the particular command is performed with respect to the particular parameter. When the sub-routine is executed at runtime of the execution routine, the variable is usable to indirectly access current configuration data of the parameter. In one exemplary implementation, Reflection is used at runtime of the sub-routine, to create an XPATH-value pair based on the XML attribute, and the retrieval of the configuration data is based on the XPATH-value pair.

In this manner, computer programs that conform to syntax rules defined for particular CLIs, GUIs, or programming languages are automatically created (for example, the get, set, enable, and disable routines specified by Windows® PowerShell, for each of the various parameters that are accepted by such routines), without custom coding numerous sets of computer-executable instructions. Code with reduced errors and a standardized base with respect to custom code is effected. As changes occur to command specifications, new code can be efficiently and quickly generated.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a simplified functional block diagram of an exemplary computing environment.

FIG. 2 is a flowchart of a method for automatically generating a set of imperative-language computer-executable instructions for performing an administrative task of the computing environment shown in FIG. 1.

FIG. 3 is a simplified functional block diagram illustrating aspects of an architecture, which may implement or use aspects of the computing environment shown in FIG. 1 and/or the method shown in FIG. 2, to automatically generate a set of imperative-language computer-executable instructions for performing an administrative task of a computing environment.

### DETAILED DESCRIPTION

The code generation techniques discussed herein enhance the efficiency of the coding process for generating code that performs administrative tasks of stand-alone and network, client- and server-based computing environments, and ensure that the resulting code is consistent, flexible to change, and relatively error-free. A declarative programming language such as XML is used, along with a transformative language such as XSL,to automatically generate imperative-language computer programs that perform predetermined administrative tasks. Exemplary generated computer programs are the verbs defined for the Windows® PowerShell command line interface (“CLI”) and scripting language, including but not limited to the get, set, enable, and disable commands that have multiple parameters associated therewith. It will be understood, however, that various types of data representations from various types of source documentation may be created using now known or later developed declarative and imperative programming languages.

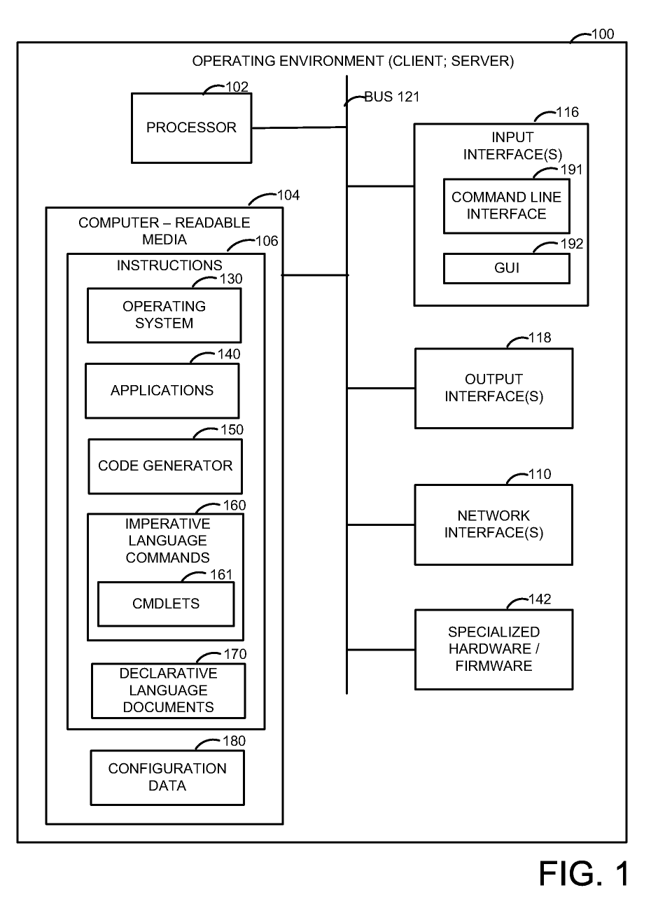

Turning now to the drawings, where like numerals designate like components, FIG. 1 is a simplified functional block diagram of an exemplary computing environment 100, with which techniques for using a declarative programming language to automatically generate imperative language computer-executable instructions that perform administrative tasks may be implemented or used. Computing environment 100 is indicative of a wide variety of general-purpose, special-purpose, client- or server-based, stand-alone or networked computing environments. Computing environment 100 may be, for example, a type of computer, such as a personal computer, a workstation, a server, a portable device, a laptop, a tablet, or any other type of stand-alone or networked computing device now known or later developed. Computing environment 100 may also be a distributed computing network or Internet-based service, for example.

One or more components shown in FIG. 1 may be packaged together or separately to implement functions of computing environment 100 (in whole or in part) in a variety of ways. As shown, a bus 121 carries data, addresses, control signals and other information within, to, or from computing environment 100 or components thereof.

Input interface(s) 116 are physical or logical elements that facilitate receipt of input to computing environment 100. Input may be collected using any type of now known or later-developed physical or logical elements. Examples of the physical or logical elements with which input may be collected include but are not limited to one or more of the following: a graphical user interface (“GUI”) 192, CLI 191, and/or devices such as remote controls, displays, mice, pens, styluses, trackballs, keyboards, microphones, and scanning devices.

Users such as system administrators generally manage the resources of computing environment 100 (resources may be any hardware, software, data, or network components, including but not limited to files, directories, programs, or devices) through the performance of administrative tasks, which are directed to be performed by the users via input interfaces such as CLI 191 and GUI 192. Examples of common administrative tasks include but are not limited to: changing directories; copying, re-naming, deleting, or retrieving the contents of files or directories; installing new computer programs; scanning for security threats; and listing, starting, or stopping various processes. Administrative tasks may result in the access and/or modification of configurations of resources of computing environment 100. One way users direct performance of administrative tasks is by inputting executable commands, such as commands for the Windows® PowerShell command line interface, which are referred to as cmdlets 161 (cmdlets 161 are discussed further below) at CLI 191 and/or GUI 192.

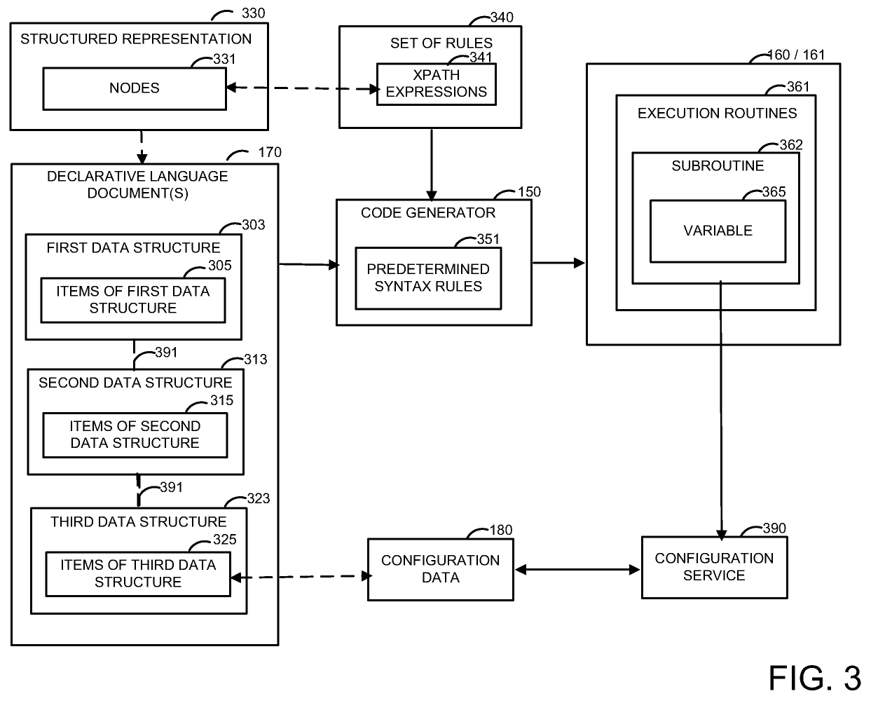

Generally, managed resources or sets thereof that may be the subject of administrative tasks have certain configuration data 180 associated therewith. Configuration data 180 represents one or more items of information about a state and/or status of a property of a particular managed resource/set, such a color, user selection or display status, process status, scan-job/iteration number, memory/storage usage, and the like. In one possible implementation, configuration data 180 is stored in temporary or persistent memory locations of computing system 100 (as shown, configuration data 180 is stored in computer-readable media 104, which is discussed further below) and is accessible to components of computing system 100 (such as operating system 130, also discussed further below) via a configuration service (such as configuration service 390 shown and discussed in connection with FIG. 3).

Output interface(s) 118 are physical or logical elements that facilitate provisioning of output from computing environment 100. Output may be provided using any type of now known or later-developed physical or logical elements, such as one or more of the following: GUI 192, CLI 191, and/or output devices such as displays, printers, speakers, disk drives, and the like.

Network interface(s) 110 are one or more physical or logical elements that enhance the ability of computing environment 100 to receive information from, or transmit information to, another computing environment (not shown) via a communication medium. Examples of communication media include but are not limited to: wireless or wired signals; computer-readable media (such as computer-readable media 104, discussed further below); computer-executable instructions (such as computer-executable instructions 106, discussed further below); communication hardware or firmware; and communication protocols or techniques.

Specialized hardware/firmware 142 represents any hardware or firmware that implements functions of computing environment 100. Examples of specialized hardware/firmware 142 include encoder/decoders (“CODECs”), decrypters, application-specific integrated circuits, secure clocks, and the like.

A processor 102, which may be one or more real or virtual processors, controls functions of computing environment 100 by executing computer-executable instructions 106 (discussed further below).

Computer-readable media 104 represent any number and combination of local or remote components, in any form, now known or later developed, capable of recording, storing, or transmitting computer-readable data, such as instructions 106 (discussed further below) executable by processor 102, and configuration data 180. In particular, computer-readable media 104 may be, or may include: a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; a paper tape; a punch card; or any combination thereof. Computer-readable media 104 may also include transmission media and data associated therewith. Examples of transmission media/data include, but are not limited to, data embodied in any form of wireline or wireless transmission, such as packetized or non-packetized data carried by a modulated carrier signal.

Computer-executable instructions 106 represent any signal processing methods or stored instructions that electronically control predetermined operations on data. In general, computer-executable instructions 106 are implemented as software programs according to well-known practices for component-based software development, and encoded in computer-readable media (such as one or more types of computer-readable media 104). Software programs may be combined or distributed in various ways.

One example of a software program is operating system 130, which may be a type and/or version of the Microsoft® Windows® operating system. In one possible implementation, operating system 130 includes both a component-based framework and an administrative tool framework that interacts with the component-based framework. Generally, the component-based framework supports components (including properties and events), objects, inheritance, polymorphism, and reflection, and provides an object-oriented component-based application programming interface (“API”) such as that of the Microsoft® .NET™ framework.

An administrative tool framework supports the use and development of administrative tools to automate a range of administrative tasks of computing environment 100. One example of an administrative tool framework is the Windows® PowerShell command line interface and scripting language, which, among other things, enables a user of GUI 192 or a CLI 191 to use cmdlets 161 to direct performance of various administrative tasks of computing environment 100. Although cmdlets are referred to as computer programs, it will be understood that cmdlets are not necessarily stand-alone executable programs. In some cases, scripts having multiple command lines may be used to tie multiple cmdlets together, and command lines may be executed either synchronously or asynchronously.

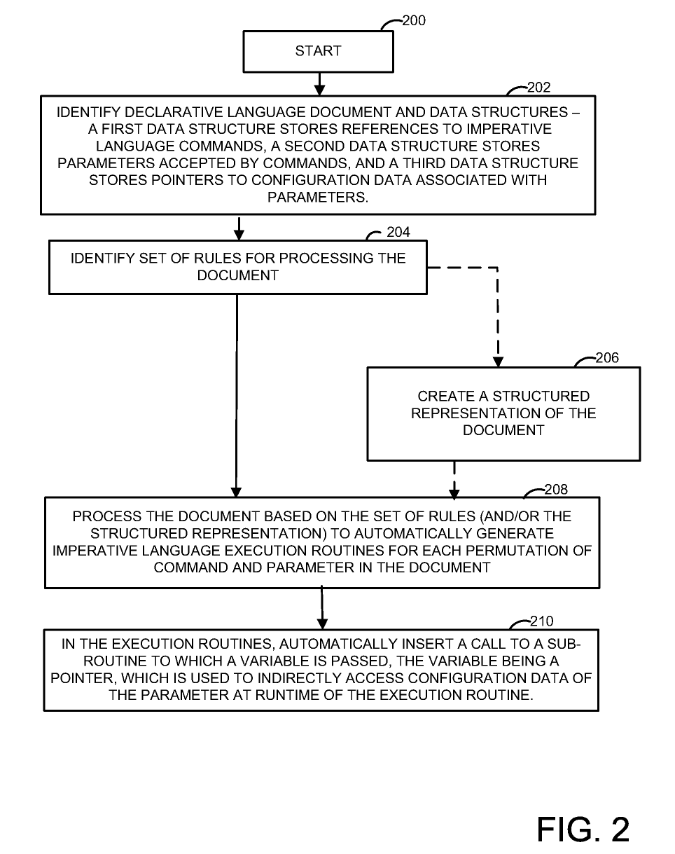

Other examples of software programs associated with computing environment 100 include but are not limited to: applications 140 (for example, email applications, word processing applications, anti-malware applications, device drivers, and the like); code generator 150; imperative language commands 160, an example of which includes cmdlets 161; and declarative language documents 170. Code generator 150, imperative language commands 160/administrative tasks 161, and declarative language documents 170 are discussed in detail in connection with FIGS. 2 and 3.

As noted above, one way users direct performance of administrative tasks within computing environment 100 is by inputting executable commands, such as cmdlets 161, at input interfaces 116 such as GUI 192 and/or CLI 191. Often, executable commands/computer programs that perform such administrative tasks are custom-coded to conform to syntax rules defined for particular administrative tool frameworks, because accessing and processing different resources may entail slightly different code. Custom coding can be time-consuming/inefficient, and result in a large, error-prone, and inflexible code base.

FIG. 2 is a flowchart of a method for automatically generating computer-executable instructions that perform administrative tasks of a computing environment such as computing environment 100. The method shown in FIG. 2 is useful to minimize repetitious custom coding that is often used to create such computer-executable instructions.

The method illustrated in FIG. 2 may be implemented by computer-executable instructions, such as computer-executable instructions associated with code generator 150, which are stored in a computer-readable medium 104 and executed by one or more general, multi-purpose, or single-purpose processors, such as processor 102. Unless specifically stated, the methods are not constrained to a particular order or sequence. In addition, some of the methods or steps thereof can occur or be performed concurrently.

The method illustrated in FIG. 2 is initially described in general terms, and an exemplary scenario of generating computer-executable instructions for the get, set, enable, and disable cmdlets 161 for use with the Windows® PowerShell CLI and scripting language is subsequently described in more detail with reference to FIG. 3.

Referring to FIG. 2, the method begins at block 200 and continues at block 202, where one or more documents, such as declarative language document(s) 170, which define at least three hierarchically-related data structures, are identified. The data structures conform to syntax rules defined for a declarative programming language. A declarative programming language is a high-level language that specifies relationships between data in source material, which relationships are used to perform computation, instead of computation being performed pursuant to a series of commands. One exemplary declarative programming language is extensible markup language (“XML”). Exemplary source material includes source code, API specifications, and the like, although many types of source material are possible. Exemplary data structures include markup elements/attributes, database fields, spreadsheet fields, and the like.

A first data structure stores references to one or more commands of an imperative programming language, such as imperative language commands 160, which correspond to administrative actions within a particular computing environment, such as computing environment 100. An imperative programming language describes a sequence of commands, representing computations to be performed by a processor. One example of an imperative programming language is a scripting language, which is a series of commands interpreted command-by-command at runtime. A second data structure stores references to parameters accepted by one or more of the imperative language commands. Exemplary parameters include references to resources or sets thereof to be managed pursuant to execution of one or more of the imperative language commands. A third data structure stores information/references that are used to indirectly access configuration data (for example, pointers to one or more locations of configuration data) associated with one or more of the parameters.

Next, at block 204, a set of rules for processing the document is identified. As indicated at block 206, one step associated with identifying the set of rules for processing the document may be to create a structured representation of the document. For example, a structured representation may be created by parsing the document into a tree structure such as a document object model (“DOM”)), which includes certain nodes corresponding to unique permutations of commands and parameters populating the first and second data structures of the document, respectively.

As indicated at block 208, the document is processed based on the identified set of rules, to automatically generate a number of execution routines. A particular execution routine is a set of computer-executable instructions, such as a script, conforming to syntax rules of the imperative programming language. In the case where a structured representation of the document is created, a particular execution routine is generated for each node corresponding to a unique permutation of a particular command and a particular parameter in the document.

As indicated at block 210, an automatically generated call to a sub-routine is inserted in each execution routine. A variable is passed via the call to the sub-routine. In one implementation, the variable is a pointer (stored by the third data structure) to configuration data associated with the particular parameter that is the subject of the particular execution routine.

At runtime of a particular execution routine (for example, when a user enters the execution routine at a command line interface such as CLI 191 or selects the execution routine at a graphical user interface such as GUI 192), the action represented by the particular command is performed with respect to the parameter. When the sub-routine is executed at runtime of the execution routine, the variable is used to indirectly access current configuration data of the parameter. Using the automatic code generation techniques discussed herein reduces time consumed in undesirable repetitious custom coding, and results in a smaller, cleaner, and more flexible-to-change code base.

Referring now to FIG. 3, aspects of an architecture, which may implement or use aspects of the computing environment shown in FIG. 1 and/or the method shown in FIG. 2 to automatically generate get, set, enable, and disable cmdlets 161 for use in connection with the Windows® PowerShell CLI and scripting language, are described. The get, set, enable, and disable cmdlets 161 perform fundamentally the same operation—accessing and processing configuration data 180 associated with a particular resource or set of resources. Each commandlet accepts various parameters that in turn are associated with the access/manipulation of different resources. It will be understood that cmdlets and the Windows® PowerShell CLI and scripting language are discussed for exemplary purposes only, and that other programming languages, commands, administrative tool environments, and combinations thereof, may be substituted.

As shown in FIG. 3, code generator 150 is operative to process one or more declarative language documents 170 (which may be represented by a structured representation such as tree structure 330) in accordance with a set of rules 340 to produce imperative-language commands 160/cmdlets 161 (including execution routine(s) 361 that call sub-routine 362 and pass a variable 365 thereto) in accordance with predetermined syntax rules 351. In one possible implementation, sub-routine 362 utilizes configuration service 390 to retrieve configuration data 180 from backend temporary or persistent memory locations, based on values of variable 365.

In an exemplary scenario, declarative language document 170 is an XML document, which includes a number of elements and attributes thereof, including a first data structure 303, a second data structure 313, and a third data structure 323. Items of data 305 that populate first data structure 303 are references (such as strings, identification numbers, or other values) to one or more of the get, set, enable, or disable commands. For example, separate declarative language documents may be used to define references to individual commands, or references to multiple commands may be included within the same document (using particular properties/attribute values, for example). The parameters/items of data 315 that populate second data structure 313 are references (such as objects that can be manipulated via the Windows® PowerShell scripting language) to particular parameters accepted by the commands referred to in the first data structure. For example, parameter references may be references to particular resources/sets of resources of computing environment 100, such as files, directories, programs, or devices, or expressions relating thereto. Items of third data 325 that populate third data structure 323 are references (for example, strings or other values such as names, identification numbers, and the like) that are used to indirectly access configuration data 180, such as states of properties of particular resources/sets of resources of computing environment 100 (for example, color, process status, processes, scan-job/iteration number, memory usage, etc.) Items of third data may be custom attributes that serve as pointers to storage locations. Parameters/resources and configurations thereof may be generic and user-selectable, or alternatively users may have access to declarative language definitions. It will be understood that additional data structures are also possible, among others, one or more data structures for storing enumerations.

Declarative language document 170 may contain either parsed or unparsed data. There is generally one root element in declarative language document 170, no part of which appears in the content of any other element. For all other elements, element start-tags and end-tags are within the content of other elements, nested within each other to define hierarchical relationships. Hierarchical associations 391 between first, second, and third data structures 303, 313, and 323, and items of first data 305, items of second data 315, and items of third data 323, may be specified by such nesting.

The elements and attributes that comprise the data structures of XML document 170 are instructions conforming to an XML schema. At a high level, an XML schema includes: (1) a global element declaration, which associates an element name with an element type, and (2) a type definition, which defines attributes, sub-elements, and character data for elements of that type. Attributes of an element specify particular properties of the element using a name/value pair, with one attribute specifying a single element property.

Generally, the specific XML schema to which data structures 303, 313, and 323 of declarative language document 170 conform may be created based on the desired data representation of the particular source material. In the exemplary scenario, a specific XML schema can be defined based on the API specifications for the Windows® PowerShell get, set, enable, and disable commands, which, among other things, specify the commands and parameters accepted thereby.

Referring again to the components of the architecture shown in FIG. 3, in an exemplary scenario set of rules 340 is a stylesheet, such as an XSLT stylesheet, which is linked to declarative-language document 170. A stylesheet defines how, and which parts of, the data within an XML document, such as declarative-language document 170, is to be processed, and what the output, such as imperative-language instructions 160/cmdlets 161, will be. To implement or use an XSLT stylesheet, it may be desirable to create a structured representation of the XML document being processed. As shown, declarative-language document 170 is parsed into tree structure 330, which in one possible implementation is a document object model (“DOM”). A DOM may include nodes 331 of several types, including a document node, which may be the root node, element nodes, attribute nodes, and text nodes. Any element may have attributes or text, including attributes themselves.

As shown, structured representation 330 includes nodes 331 corresponding to unique permutations of elements and attributes of the XML document—in the exemplary scenario, a portion of the tree structure would include unique permutations of commands and parameters populating the first and second data structures 303 and 313, respectively. That is, certain nodes of the tree structure would correspond to unique permutations of a particular get, set, enable, or disable command represented by a particular item of first data 305, and a particular parameter/resource (or combination of multiple parameters/resources) accepted by the particular command, which is represented by a particular item of second data 315. The XSLT stylesheet would generally include expressions usable to retrieve values, such as nodes of structured representation 330 (for example a node corresponding to unique permutations of a particular command and a particular parameter), which serve as instructions to create output (such as computer-executable instructions that conform to predetermined syntax rules 351 to form execution routine 361 and sub-routine 362 ) from code generator 150. Essentially, an XPATH expression lists all the elements and/or attributes that lead to the nodes that are of interest, and a list of nodes that match the XPATH is returned from an XPATH query. To include an attribute in an XPATH expression, its name is prefixed with the @ character.

In one possible implementation, code generator 150 itself is an XSLT processor, which reads both declarative-language document 170 (and/or structured representation 330) and XSLT stylesheet 340, and applies an XSLT transformation thereto. The XSLT transformation relies on XPATH to define the parts of the XML data that are to undergo transformation—the stylesheet defines a template, which uses XPATH and specifies how the identified XML data is to be transformed. The XSLT processor recursively finds each item of XML data (such as permutations of items of first data 305, items of second data 315, and/or items of third data 325) and applies the transformation.

In the exemplary scenario, the output of code generator 150 is a number of sets of computer-executable instructions referred to execution routines 361, which conform to predetermined imperative-language syntax rules 351 (such as syntax rules for the Windows® PowerShell scripting language). With respect to cmdlets 161, a particular execution routine corresponds to a particular get, set, enable, or disable command, and one or more parameters accepted by the particular command. The execution routine is code that informs the Windows® PowerShell runtime environment of all of the parameters the particular command accepts, and an attribute is applied to each parameter that holds an XPATH mapping (as discussed below, a technique such as Reflection is used to at runtime to iterate through attributes created by the code generator, to create XPATH-value pairs.) This particular step generates 100% of the get, set, enable, and disable code that runs in conjunction with the supporting infrastructure, and such code is approximately 70% of the code that Windows® PowerShell requires, eliminating a substantial amount of custom coding. Within each execution routine 361, code generator 150 includes a call to sub-routine 362, to which is passed variable 365. Variable 365 is a particular item of third data 325 (e.g., a pointer to a location in a computer-readable memory where configuration data 180 is stored) associated with the particular item of second data 315 (i.e., the particular parameter with which the configuration data is associated) that is the subject of the execution routine. Sub-routine 362 may be a common helper function that creates requests for access and/or manipulation of configuration data 180 via a separate configuration service 390.

At runtime of a particular execution routine 361/sub-routine 362—for example, when a particular execution routine is selected by a user at a command line interface such as CLI 191 or a graphical user interface such as GUI 192—values of variable 365 may be ascertained using a technique such as Reflection. Reflection iterates through attributes created by the code generator in execution routines 361 to create XPATH-value pairs. The XPATH-value pairs point to backend locations where configuration data 180 is stored. An array of XPATH-value pairs may be submitted to configuration service 390, which accesses and/or manipulates configuration data 180 in accordance with the action (for example, get, set, enable, disable) specified by the particular execution routine. This allows for a highly generic implementation, where differences between parameters and the configuration data can be mitigated through mapping.

In this manner, computer programs that conform to syntax rules defined for particular programming languages or administrative tool frameworks are automatically created without time-consuming, inefficient, and error-prone custom coding. A flexible-to-change, standardized code base with reduced errors can be quickly generated. High flexibility in configuration data storage is also enabled.

Exemplary pseudo-code for implementing an exemplary execution routine, referred to as “ProcessRecord( )”, which calls a sub-routine called “PShelper( )” that handles converting properties into configuration mappings for the backend, is shown below:

[CustomAttMap Value=”ScanJob [ID={0}]\Engines”, Values=ScanJobID] public string Engines { }

The ProcessRecord can then call a helper function passing it the “this” pointer.

```
protected override void ProcessRecord( )
{
  try
  {
    PSHelper.ProcessRecord(this)
  }
  catch (Exception)
  {
  }
}
```

The operation of the PSHelper object, which gathers process values and their XPATH mappings via Reflection and creates a request that can be handled by configuration service 390, is illustrated in the pseudo-code below. The configuration service would require an interface (not shown) that accepts an array of XPATHs and values, to set data in the backend.

```
    PSHelper.ProcessRecord(Object targetClass)
{
      Use reflection to get a list of all properties with attribute “CustomAttMap”
      For each property with CustomAttMap attached to it
      {
            Use reflection to get the value of that property
            Use reflection to get the XPath template value set in the custom
attribute
            Fill in parameters required by the XPath template
              e.g. \ScanJob [ID = {0}]\Engines
                    Use Reflection to get the value of the parameter pointed to
                    by Values, in this case ScanJobID
                    Call String.Format and fill in the XPath Query (So
                    ScanJob[ID=1]\Engines might be the result.)
            Create a Named Value Pair of XPath and Value
            Add to ArrayList
    }
      Call SetNodes on the Configuration Service Interface to manipulate the value.
}
```

In the end, exemplary pseudo-code usable for implementing cmdlets 161 is shown below.

```
    [Cmdlet(VerbsCommon.Set, “FSETransportVirusScan”,
SupportsShouldProcess = true)]
public class SetFSETransportVirusScan : PSCmdlet
{
  [Parameter(Position = 0, Mandatory = false)]
  [ValidateNotNullOrEmpty]
    [CustomAttMap Value=\ScanJob [ID = {0}]\Bias, Values =
    ScanJobID]
  public string Bias { }
    [CustomAttMap Value=\ScanJob [ID = {0}]\Engines, Values =
    ScanJobID]
  public string Engines { }
  public string ScanJobID { }
  ...
  protected override void ProcessRecord( )
  {
  try
  {
    PSHelper.ProcessRecord(this)
  }
  catch (Exception)
  {
  }
  }
}
```

Various aspects of a computing environment and an architecture that is used to automatically generate computer-executable instructions that perform administrative tasks of the computing environment have been described. It will be understood, however, that all of the described components/elements need not be used, nor must the components/elements, when used, be present concurrently. Elements/components described as being computer programs are not limited to implementation by any specific embodiments of computer programs, and rather are processes that convey or transform data, and may generally be implemented by, or executed in, hardware, software, firmware, or any combination thereof.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A computer-readable medium encoded with computer-executable instructions which, when executed by a processor, perform a method for automatically generating computer-executable instructions, the method comprising:
identifying a document having plurality of data structures conforming to syntax rules defined for a declarative programming language, the plurality of data structures including
a first data structure defined to store, and populated with, items of first data representing one or more commands of an imperative programming language, each of the one or more commands comprising an action within a computing environment,
a second data structure hierarchically associated with the first data structure, the second data structure defined to store, and populated with, items of second data representing one or more parameters accepted by one or more of the commands, and
a third data structure hierarchically associated with the first data structure or the second data structure or both, the third data structure defined to store, and populated with, items of third data representing information about one or more locations of configuration data associated with the one or more parameters;
identifying a set of rules for processing the document;
processing the document based on the set of rules to automatically produce a plurality of execution routines, each execution routine comprising a set of computer-executable instructions conforming to syntax rules defined for the imperative programming language, a particular execution routine corresponding to a unique permutation of a particular command represented by a particular item of first data and a particular parameter represented by a particular item of second data, each execution routine, when executed, performing the action represented by the particular command with respect to the particular parameter.

2. The computer-readable medium according to claim 1, wherein the method step of processing further comprises:
within a particular execution routine, including a computer-executable instruction conforming to the syntax rules defined for the imperative programming language, which instruction, when executed at runtime of the particular execution routine, calls a sub-routine and passes a variable to the sub-routine, the variable comprising a particular item of third data associated with the particular parameter, the sub-routine operable to arrange for retrieval of configuration data associated with the particular parameter from a location identified by the variable.

3. The computer-readable medium according to claim 2, wherein the first, second, and third data structures conform to syntax rules defined for extensible markup language (“XML”).

4. The computer-readable medium according to claim 3, wherein the sub-routine uses Reflection to create an XPATH-value pair based on the variable, the retrieval of configuration data associated with the particular parameter based on the XPATH-value pair.

5. The computer-readable medium according to claim 2, wherein prior to the method step of processing, the method comprises
parsing the document into a tree structure, the tree structure having a plurality of nodes, at least some nodes corresponding to unique permutations of commands and parameters represented by items of first data and items of second data, respectively.

6. The computer-readable medium according to claim 2, wherein the set of rules comprises a stylesheet.

7. The computer-readable medium according to claim 6, wherein the stylesheet includes expressions usable to identify items of first data, items of second data, items of third data, or combinations thereof.

8. The computer-readable medium according to claim 7, wherein the expressions comprise XPATH expressions, the XPATH expressions including queries to items of third data usable to identify XPATH-value pairs, the XPATH-value pairs usable to indirectly access configuration data.

9. A method for automatically generating a set of computer-executable instructions, the method comprising:
identifying a document having plurality of data structures conforming to syntax rules defined for a declarative programming language, the plurality of data structures including
a first data structure defined to store, and populated with, items of first data representing one or more commands of an imperative programming language, each of the one or more commands comprising an action within a computing environment,
a second data structure hierarchically associated with the first data structure, the second data structure defined to store, and populated with, items of second data representing one or more parameters accepted by one or more of the commands represented by one or more of the items of first data, and
a third data structure hierarchically associated with the first data structure or the second data structure or both, the third data structure defined to store, and populated with, items of third data representing information about one or more locations of configuration data associated with the one or more parameters;
creating a structured representation of the document, the structured representation having a plurality of nodes, certain nodes corresponding to unique permutations of particular commands represented by a particular items of first data and particular parameters represented by particular items of second data;
processing the structured representation to automatically generate a plurality of execution routines, a particular execution routine corresponding to a particular node of the structured representation and comprising a set of computer-executable instructions conforming to syntax rules defined for the imperative programming language, a particular execution routine corresponding to a unique permutation of a particular command represented by a particular item of first data and a particular parameter represented by a particular item of second data, a particular execution routine, when executed, performing the action represented by the particular command with respect to the particular parameter;
within each particular execution routine, including a computer-executable instruction conforming to the syntax rules defined for the imperative programming language, which instruction, when executed at runtime of the particular execution routine, calls a sub-routine and passes a variable to the sub-routine, the variable comprising a particular item of third data associated with the particular parameter, the sub-routine operable to arrange for retrieval of configuration data associated with the particular parameter from a location identified by the variable;
providing a user with access to the execution routines in such a manner that the user can direct execution of the execution routines to perform administrative tasks of the computing environment.

10. The method according to claim 9, wherein the document comprises one or more markup documents.

11. The method according to claim 9, wherein the set of computer-executable instructions comprises a Microsoft® Windows® operating system PowerShell™ cmdlet.

12. The method according to claim 9, wherein the first, second, and third data structures comprise XML tags.

13. The method according to claim 12, wherein the step of generating a plurality of execution routines comprises performing an XSLT transform on the document.

14. The method according to claim 12, wherein the step of processing the structured representation further comprises:
for a particular execution routine corresponding to a unique permutation of a particular command represented by a particular item of first data and a particular parameter represented by a particular item of second data, applying an XML attribute to the particular item of second data, the XML attribute holding an XPATH mapping.

15. The method according to claim 14, wherein the variable is based on the XML attribute.

16. The method according to claim 15, wherein at runtime of the particular execution routine, the sub-routine uses Reflection to create an XPATH-value pair based on the XML attribute, the retrieval of configuration data associated with the particular parameter based on the XPATH-value pair.

17. The method according to claim 9, wherein the execution routine comprises a script executable via a command line interface associated with the computing environment.

18. The method according to claim 9, wherein the parameters comprise resources of the computing environment.

19. A system for automatically generating a set of computer-executable instructions, the system comprising:
a computer-readable storage medium; and
a processor responsive to the computer-readable storage medium and to a computer program, the computer program, when loaded into the processor, operable to identify a document having plurality of data structures conforming to syntax rules defined for a declarative programming language, the plurality of data structures including
a first data structure defined to store, and populated with, items of first data representing one or more commands of an imperative programming language, each of the one or more commands comprising an action within the computing environment,
a second data structure hierarchically associated with the first data structure, the second data structure defined to store, and populated with, items of second data representing one or more parameters accepted by one or more of the commands, and
a third data structure hierarchically associated with the first data structure or the second data structure or both, the third data structure defined to store, and populated with, items of third data representing information about one or more locations of configuration data associated with the one or more parameters,
identify a set of rules for processing the document, and
process the document based on the set of rules to automatically produce a plurality of execution routines, each execution routine comprising a set of computer-executable instructions conforming to syntax rules defined for the imperative programming language, each execution routine corresponding to a unique permutation of a particular command represented by a particular item of first data and a particular parameter represented by a particular item of second data, each execution routine, when executed, performing the action represented by the particular command with respect to the particular parameter.

20. The apparatus according to claim 19, wherein the computer-readable medium is located within a device selected from the group comprising: a client-side device and a server-side device.
